(19) United States
(12) Patent Application Publication
(10) Pub. No.: US 2019/0310836 A1
(43) Pub. Date: Oct. 10, 2019

(54) SYSTEMS AND METHODS FOR AUTOMATED CONTROLLER PROVISIONING

(71) Applicant: Johnson Controls Technology Company, Auburn Hills, MI (US)

(72) Inventor: Gregory T. Reichl, Kaukauna, WI (US)

(73) Assignee: Johnson Controls Technology Company, Auburn Hills, MI (US)

(21) Appl. No.: 15/949,828

(22) Filed: Apr. 10, 2018

(51) Int. Cl. G06F 8/61

(52) U.S. Cl. CPC G06F 8/61; H04W 84/12

(57) ABSTRACT

A portable device includes a communication driver and a controller load circuit. The communication driver is configured to facilitate communication between the portable device and a plurality of controllers on a building network and between the portable device and one or more personal computing devices. The plurality of controllers are configured to control building equipment for a building. The controller load circuit is configured to receive a controller provisioning file and identify controller packages from the controller provisioning file. Each controller packing includes provisioning information for a corresponding controller of the plurality of controllers. The controller load circuit is also configured to install each controller package on the corresponding controller.

### BACKGROUND

The present disclosure relates generally to the field of building management systems, and more particularly to controller provisioning in a building management system. A building management system (BMS) is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

In a BMS, controllers control the operation of building equipment and devices to provide heating, cooling, ventilation, and other features to a building. Controllers may be communicable via a building network, for example based on a BACnet or MSTP approach. When a new building management system is installed, controllers need to be provisioned (i.e., configured, provided with application logic, firmware, parameters, tags, etc.) to set-up the controllers to perform the desired functions. Existing provisioning approaches are time-consuming and expensive.

### SUMMARY

One implementation of the present disclosure is a portable device. The portable device includes a communication driver and a controller load circuit. The communication driver is configured to facilitate communication between the portable device and a plurality of controllers on a building network and between the portable device and one or more personal computing devices. The plurality of controllers are configured to control building equipment for a building. The controller load circuit is configured to receive a controller provisioning file and identify controller packages from the controller provisioning file. Each controller packing includes provisioning information for a corresponding controller of the plurality of controllers. The controller load circuit is also configured to install each controller package on the corresponding controller.

In some embodiments, the one or more personal computing devices include a set-up computer and a mobile device. The set-up computer is configured to create the controller provisioning file and provide the controller provisioning file to the portable device, and the mobile device is configured to receive status updates on the installation of controller packages from the portable device.

In some embodiments, the set-up computer is located at a remote location from the building. The portable device is portable from the remote location to the building. The portable device is configured to be disconnected from the building network after installation is complete.

In some embodiments, the communication driver facilitates communication between the portable device and the plurality of controllers using BACnet or MSTP and between the portable device and the mobile device using Wi-Fi.

In some embodiments, the portable device is configured to be coupled to a first controller of the plurality of controllers and to draw power from the first controller. In some embodiments, the first controller is communicable via the building network and wherein the portable device accesses the building network via the first controller. In some embodiments, the controller packages include applications, parameters, tags, commissioning report files, sensor-actuator bus provisioning, and/or firmware.

Another implementation of the present disclosure is a method for provisioning controllers. The method includes receiving, by a portable device, a controller provisioning file. The method also includes configuring, by the portable device, controller packages based on the controller provisioning file for a plurality of controllers. Each controller is communicable with the portable device via a building network. The method also includes providing, by the portable device, a graphical user interface to a user mobile device via a wireless network, and receiving, by the portable device from the user mobile device, a user request to initiate installation of selected controller packages. The method also includes installing the selected controller packages on corresponding controllers of the plurality of controllers.

In some embodiments, the controller provisioning file is generated by a set-up computer and transmitted from the set-up computer to the portable device. In some embodiments, the controllers control building equipment in a building to provide heating or cooling to the building and the set-up computer is located remotely from the building. In some embodiments, the building network is BACnet or MSTP and the wireless network is a Wi-Fi network.

In some embodiments, the method also includes accessing, by the portable device, the building network via a first controller, and drawing, by the portable device, electrical power from the first controller. In some embodiments, the controller packages include applications, parameters, tags, commissioning report files, sensor-actuator bus provisioning, and/or firmware. In some embodiments, the method also includes selectively disconnecting the portable device from the mobile device during installation of the controller packages.

Another implementation of the present disclosure is a method. The method includes generating, by a personal computer at a first location, a controller provisioning file, importing the controller provisioning file from the personal computer to a portable device, transporting the portable device to a second location, and connecting the portable device to a first controller of a plurality of controllers. The plurality of controllers are communicable via building network. The method also includes generating a communication session between the portable device and a user mobile device, receiving, by the portable device from the user mobile device, a user request to install controller packages from the controller provisioning file on one or more selected controllers of the plurality of controllers, and installing, by the portable device via the building network, the controller packages on the one or more selected controllers.

In some embodiments, the method also includes transmitting, from the portable device to the user mobile device, status updates on installation of the controller packages, and providing, on the user mobile device, a graphical user interface comprising the status updates. In some embodiments, the method also includes selectively connecting and disconnecting the user mobile device from the portable device during installation of the controller packages on the one or more selected controllers.

In some embodiments, the method also includes powering the portable device by drawing electrical power from the first controller. In some embodiments, the plurality of controllers control building equipment to heat or cool a building at the second location. In some embodiments, the method also includes reconfiguring, by the portable device, the controller provisioning file to generate the controller packages, the controller packages configured to be transmitted via the building network.

### BRIEF DESCRIPTION OF THE DRAWINGS

FIG. 1 is a drawing of a building equipped with a HVAC system, according to some embodiments.

FIG. 2 is a block diagram of a waterside system which can be used to serve the building of FIG. 1, according to some embodiments.

FIG. 3 is a block diagram of an airside system which can be used to serve the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is perspective view of a mobile access point (MAP) device, according to some embodiments.

FIG. 7 is a schematic block diagram of the MAP device of FIG. 6, according to some embodiments.

FIG. 8 is a schematic diagram of a system for providing the MAP device of FIG. 6 with a controller provisioning file, according to some embodiments.

FIG. 9 is a schematic diagram of a system for controller provisioning with the MAP device of FIG. 6, according to some embodiments.

FIG. 10 is a flowchart of a process for controller provisioning with the system of FIG. 8, according to some embodiments.

FIG. 11 is a flowchart of a process for controller provisioning with the system of FIG. 9, according to some embodiments.

FIG. 12 is a first example user interface generated by the MAP device of FIG. 6, according to some embodiments.

FIG. 13 is a second example user interface generated by the MAP device of FIG. 6, according to some embodiments.

FIG. 14 is a third example user interface generated by the MAP device of FIG. 6, according to some embodiments.

FIG. 15 is a fourth example user interface generated by the MAP device of FIG. 6, according to some embodiments.

### DETAILED DESCRIPTION

### Building HVAC Systems and Building Management Systems

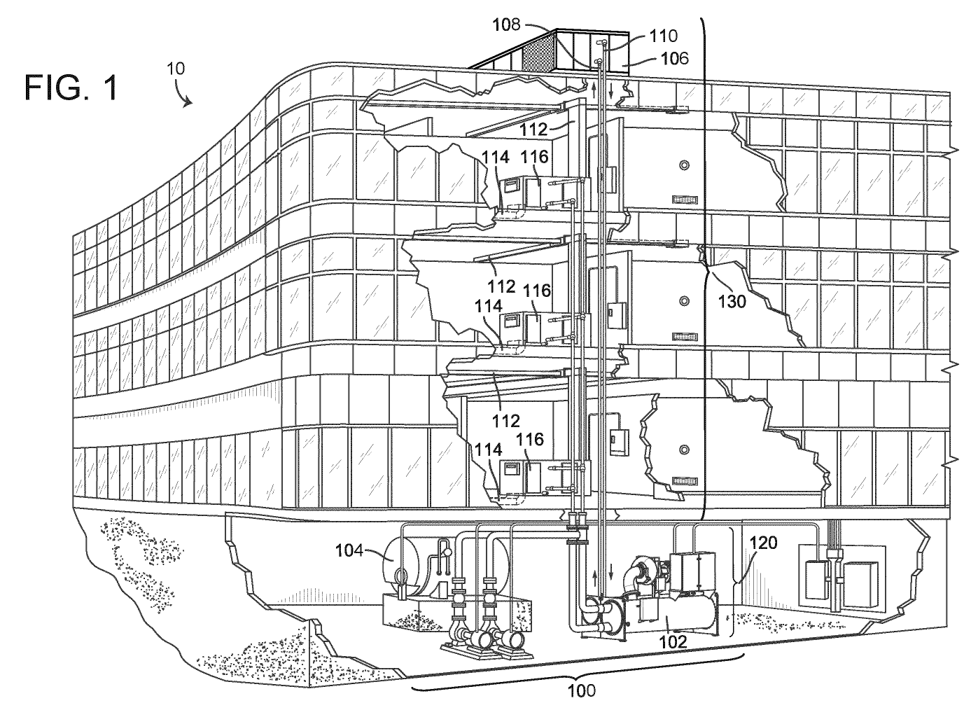

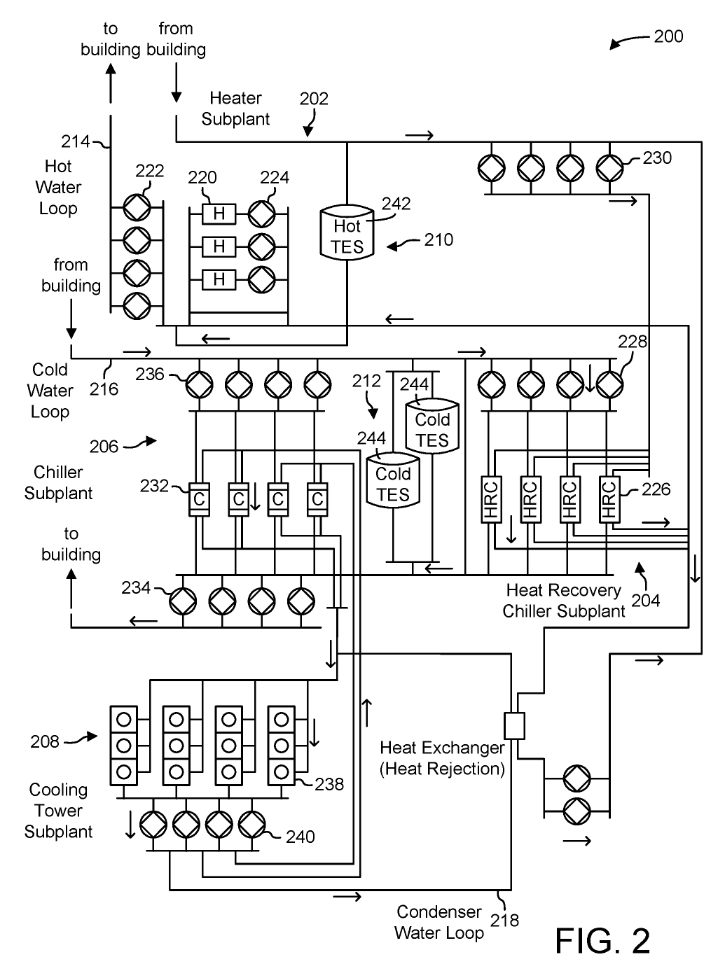

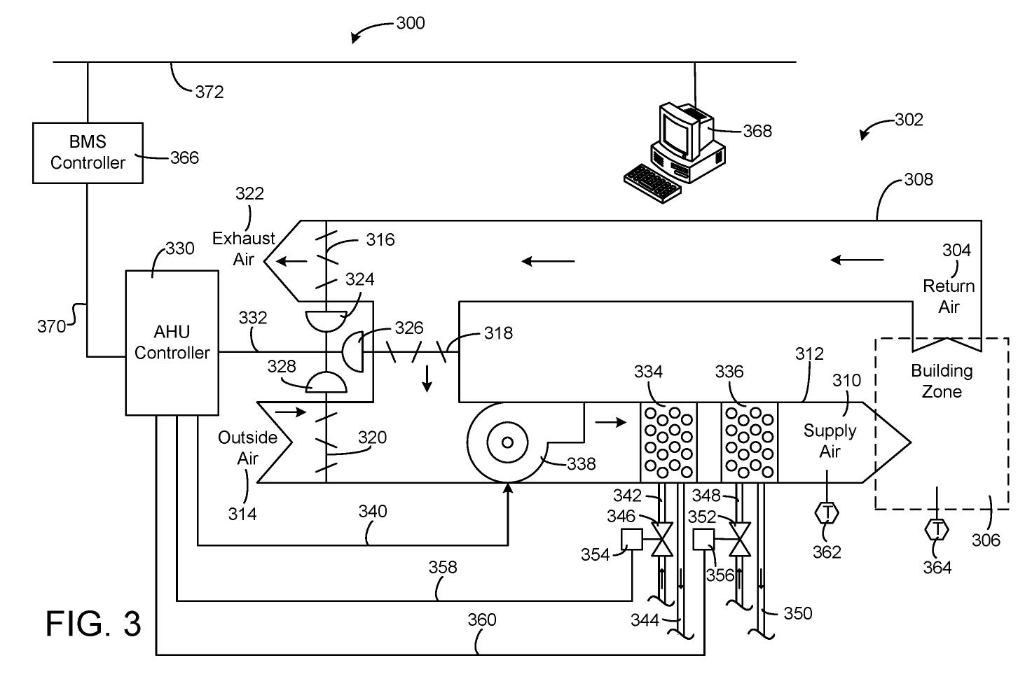

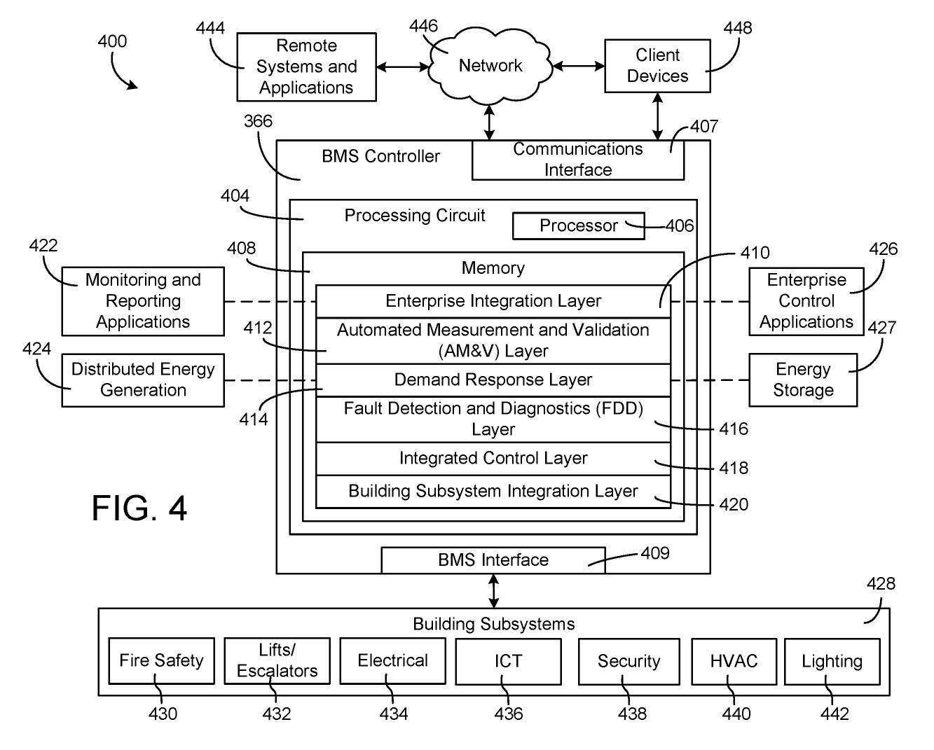

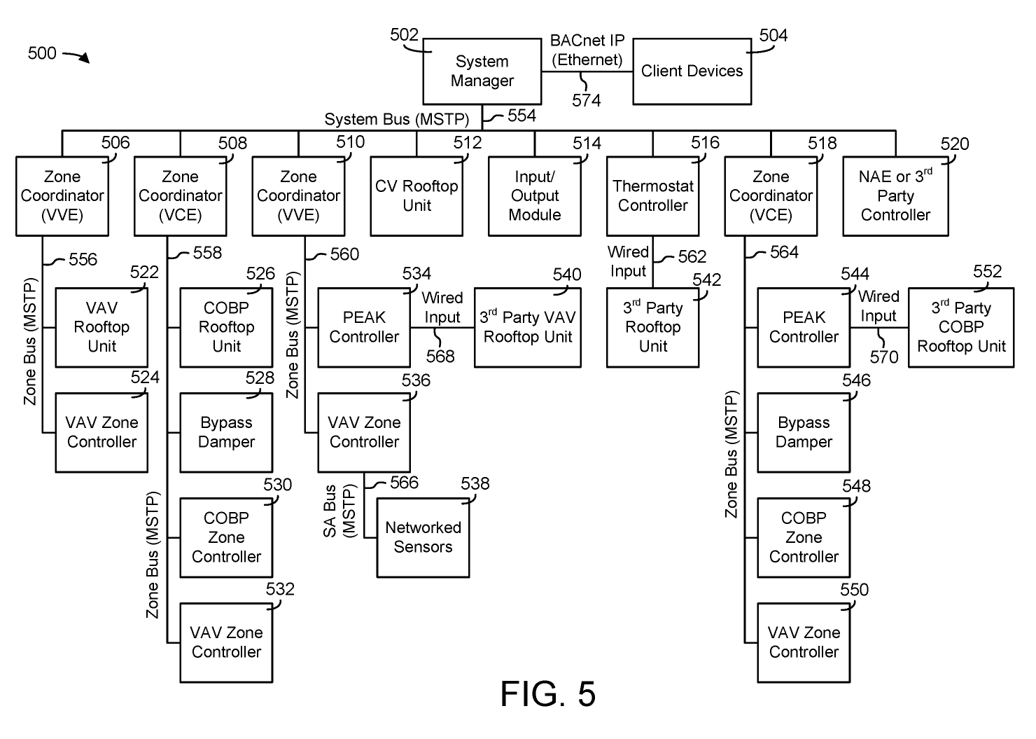

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200(e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (TOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

Controller Provisioning with Mobile Access Point Device

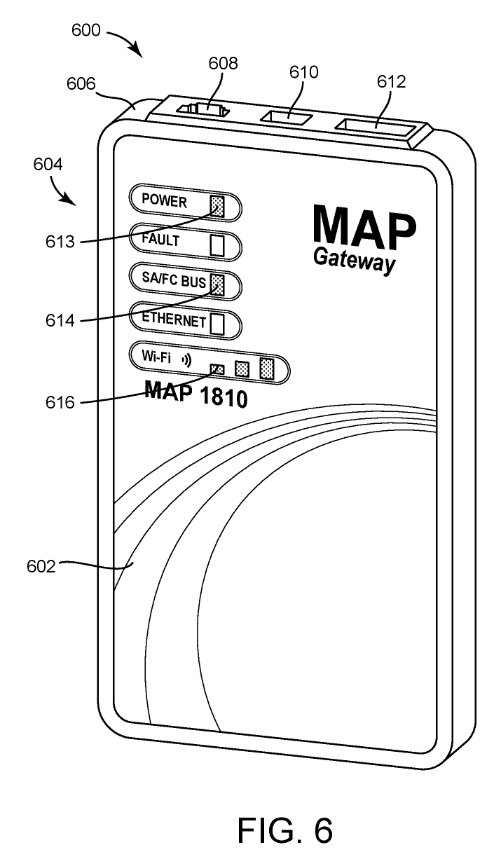

Referring now to FIGS. 6-11, systems and methods for automated controller provisioning with a portable device are shown, according to exemplary embodiments. More particularly, a mobile access point (MAP) gateway device (“MAP device”) is structured to receive and store controller configuration files, connect to controllers via a building network, and load the controller configuration files onto various controllers. A MAP device is a portable, pocket-sized electronic device configured to provide communication between a user device (e.g., computer, mobile phone, etc.) and building devices/equipment of a building management system.

FIG. 6 shows a MAP device 600, according to an exemplary embodiment. The MAP device 600 includes a face 602 with a variety of indicator lights 604 and a top end 606 with a Ethernet port 608, a sensor-actuator/field-controller bus (SA/FC bus) port 610, and a universal serial bus (USB) port 612. The ports 608-612 allow the MAP device 600 to be connected to a variety of networks, including the interne and building networks (e.g., BACnet, MSTP), as well as to a variety of devices, including a personal computer, a field controller, a power source, etc. The MAP device 600 also provides a wireless access point. That is, the map device 600 generates a Wi-Fi network that can be accessed by a Wi-Fi enabled device (e.g., smartphone, tablet, laptop) to interact with the MAP device 600 and/or controllers or other devices connected to the MAP device 600 (e.g., via a building network).

The indicator lights 604 indicate the status of certain functions of the MAP device 600. For example, the power light 613 lights up when the MAP device 600 has power, and the SA/FC bus light 614 lights up when the MAP device 600 is in communication with an SA/FC bus (i.e., with a building network). The Wi-Fi indicator lights 616 indicate that the MAP device 600 is providing the wireless access point and indicate the strength of the network provided.

Beyond indicator lights 604, the example MAP device 600 as shown in FIG. 6 does not include a display or means for direct user input (e.g., touchscreen, buttons, switches). Thus, the MAP device 600 serves as a gateway, facilitating communication between a user device (e.g., smartphone, tablet, laptop, desktop computer) or other building management device (e.g., building management server) and controllers or other building devices/equipment. In addition, as described in detail below, the present disclosure relates to MAP device 600 playing an active role in provisioning controllers.

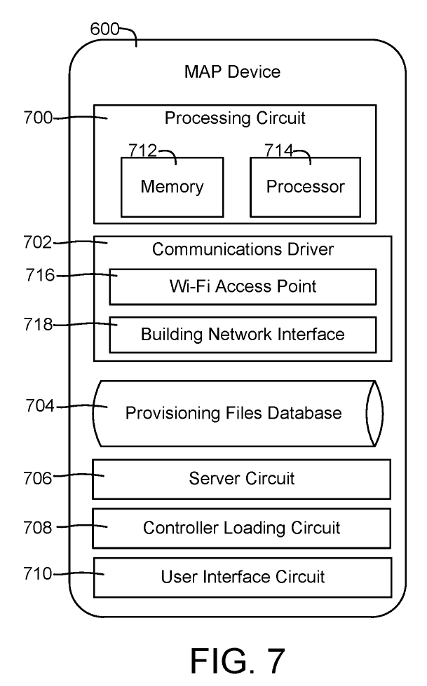

Referring now to FIG. 7, a block diagram of the MAP device 600 is shown, according to an exemplary embodiment. The MAP device 600 includes various circuits, drivers, and database components that allow the MAP device 600 to automatically provision controllers. More particularly, the MAP device 600 is configured to receive controller provisioning files, store controller provisioning files, convert a controller provisioning file into controller packages corresponding to particular controllers, communicate with the controllers via a building network, and load the controller packages onto the corresponding controllers. Accordingly, the MAP device 600 includes a processing circuit 700, a communications driver 702, a provisioning files database 704, a server circuit 706, a controller loading circuit 708, and a user interface circuit 710.

The processing circuit 700 is configured to control the MAP device 600 as described herein. the processing circuit 700 includes memory 712 and processor 714. The processor may be implemented as a general-purpose processor, an application-specific integrated circuit, one or more field programmable gate arrays, a digital signal processor, a group of processing components, or other suitable electronic processing components. The one or more memory devices of memory 712 (e.g., RAM, ROM, NVRAM, Flash Memory, hard disk storage, etc.) may store data and/or computer code for facilitating at least some of the various processes described herein. In this regard, memory 712 may store programming logic that, when executed by the processor 714, controls the operation of the MAP device 600.

The communications driver 702 facilitates communication between the MAP device 600 and a variety of types of devices, including user devices (e.g., desktop computers, laptops, smartphones, tablets) as well as building equipment and controllers. In some cases, the communications driver 702 allows a first type of device communicating over a first type of network (e.g., a smartphone or tablet communicating via a Wi-Fi network) to communicate with a second type of device communicating over a second type of network (e.g., a field controller that communicates via BACnet or MSTP) via the MAP device 600. Accordingly, the communications driver 702 creates a gateway for a user device not typically configured to access a building network to exchange communications with building equipment and controllers on a building network.

More particularly, the communications driver 702 includes a Wi-Fi access point 716 and a building network interface 718. The Wi-Fi access point 716 generates a wireless Wi-Fi network that can be accessed by one or more user devices. The MAP device 600 thereby provides its own Wi-Fi signal and is not reliant on the availability of an external Wi-Fi network. As described below in reference to FIGS. 7-10, the Wi-Fi access point 716 allows the MAP device 600 to receive controller provisioning files from a set-up computer and provide a graphical user interface on a user device.

The building network interface 718 facilitates communication between the MAP device and one or more building networks. The building network interface 718 is configured to facilitate communications over one or more of a variety of types of building networks, including BACnet, MSTP, etc. The building network interface 718 is also configured to translate communications between a format suitable for exchange over a Wi-Fi network into a format suitable for exchange over the building network, and vice versa.

The building network interface 718 is also configured to draw power from the building network to power the MAP device 600. A separate power source may therefore not be required for operation of the MAP device 600. The MAP device 600 may also include a battery or other portable power source.

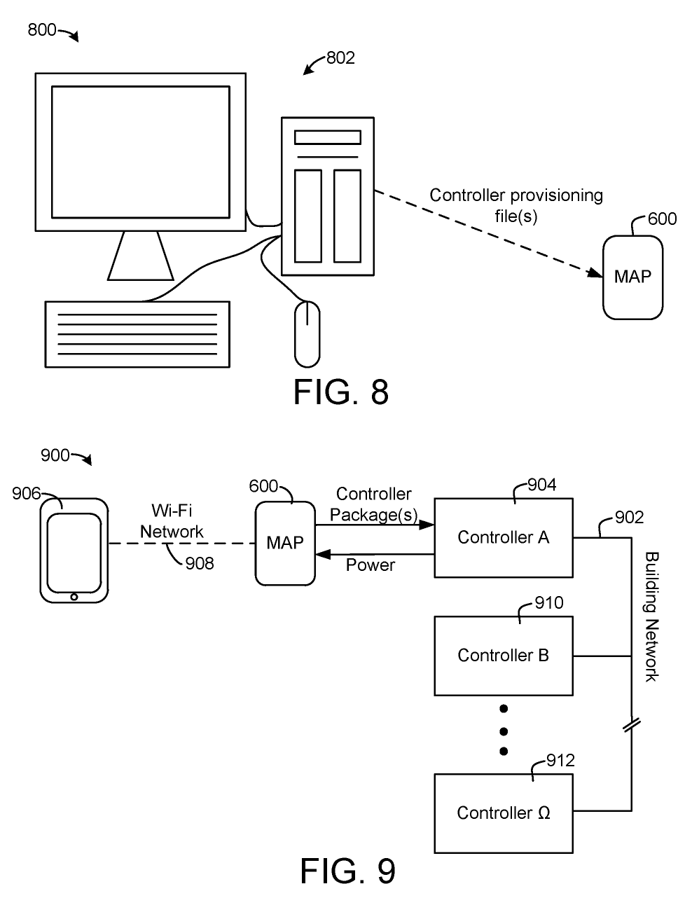

The provisioning files database 704 stores files for provisioning controllers. More particularly, the provisioning files database 704 may store controller provisioning files in a format provided to the MAP device 600 by a set-up computer as shown in FIG. 8 and described in detail below, as well as controller packages formatted for delivery to and loading onto particular controllers, as shown in FIG. 9 and described in detail below. The provisioning files database 704 is capable of storing provisioning files corresponding to multiple controllers, spaces, buildings, and sites, such that the MAP device 600 can be loaded with provisioning files at a first location and then taken to multiple sites to provision controllers at those sites.

The server circuit 706 is structured to support the loading of controller packages onto controllers by facilitating navigation of the building network that serves the controllers. When the MAP device 600 is connected to a building network via building network interface 718, the server circuit 706 determines the structure of the building network, discovers and identifies the controllers and other devices present on the building network, and determines network addresses for the controllers or other devices. The server circuit 706 thereby provides a list of controllers available on the building network and facilitates communication with a desired controller.

The controller loading circuit 708 is structured to prepare controller packages based on a controller provisioning file provided by a set-up computer and to load the controller packages onto the appropriate controllers. The controller loading circuit 708 accesses the provisioning files database to access a controller provisioning file as provided by a set-up computer. The controller provisioning file contains various programs, data, applications, firmware, etc. to be loaded onto a variety of controllers. The controller loading circuit 708 divides the controller provisioning file into controller packages. Each controller package is associated with a particular controller and includes the applications, parameters, tags, commissioning report file, firmware, and/or sensor-actuator bus provisioning, etc. to be loaded onto that particular controller. The controller loading circuit 708 reformats the controller packages as need to facilitate communication of the content of the controller packages to the corresponding controllers over the building network. The controller loading circuit 708 may store the controller packages in the provisioning files database 704.

The controller loading circuit 708 is also structured to load the controller packages onto the controllers via the building network. Based on network address information from the server circuit 706, the controller loading circuit 708 causes each controller package to be transmitted to the corresponding controller to load the controller package onto that controller.

The user interface circuit 710 generates a graphical user interface that is provided to a user device via Wi-Fi access point 716. The graphical user interface allows a user to choose which controllers to provision (i.e., which controller packages to load onto corresponding controllers), initiate the loading of controller packages, monitor loading progress, pause loading, cancel loading, and/or view other statuses or metrics relating to controller provisioning. Accordingly, the user interface circuit 710 receives a user selection of options to initiate the loading process, pause loading, cancel loading, etc. for all controllers or for particular controllers, and provides the controller loading circuit 708 with a corresponding command. The user interface generator 710 thereby instructs the controller loading circuit 708 to carry out the function desired by the user.

Referring now to FIG. 8, a schematic diagram of a system 800 for providing controller provisioning files to a MAP device 600 is shown, according to an exemplary embodiment. system 800 includes set-up computer 802 communicably coupled to MAP device 600.

As shown in FIG. 8, the set-up computer 802 is a desktop personal computer. In some embodiments, the set-up computer 802 is a laptop, tablet, or other user computer device. The set-up computer 802 may be located remote from the controllers to be provisioned, for example at an office of a BMS installation professional.

The set-up computer 802 is structured to allow a user to build, customize, and otherwise prepare a controller provisioning file that includes the applications, tags, firmware, etc. needed by the controllers in a building management system (e.g., BMS 500 of FIG. 5). For example, the set-up computer 802 may run a system configuration tool (SCT) that supports engineering, design, and installation of a building management system. The SCT may provide a visually-intuitive configuration process, a step-by-step wizard to assist with system configuration, and simulations of the system to test set-up. The SCT may provide templates for controller provisioning files that can be customized by a user to efficiently generate a controller provisioning file for a particular building management system. The controller provisioning file may also be auto-generated based on user-selection of higher-level system features and preferences. The set-up computer 802 generates the controller provisioning file in a MAP-to-Controller (.m2c) file format.

The set-up computer 802 then connects to the MAP device 600 to generate a communication session between the set-up computer 802 and the MAP device 600. In the embodiment shown, the set-up computer 802 connects to the Wi-Fi access point 716 of the MAP device 600 via a wireless network generated by the Wi-Fi access point 716. In other embodiments, the set-up computer 802 connects to the MAP device 600 via a cable connected to Ethernet port 608 or USB port 612 of the MAP device 600. The set-up computer 802 then transfers the controller provisioning file onto the MAP device 600 (i.e., copies the controller provisioning file onto the MAP device 600, moves the controller provisioning file onto the MAP device 600). The set-up computer may receive a confirmation from the MAP device 600 of receipt of the controller provisioning file. For example, the MAP device 600 may provide the set-up computer 802 with a list of files stored on the MAP device 600. The set-up computer 802 may store multiple controller provision files on one MAP device 600.

The set-up computer 802 can then be disconnected from the MAP device 600 as the MAP device 600 is transported to the location of the controllers to be provisioned (i.e., a building being installed with a building management system). Thus, the systems and methods for controller provisioning described herein do not require the set-up computer 802 to be at the location of the controllers to be provisioned or to play an active role in controller provisioning. Instead, as shown in FIG. 9 and described in detail below, once the controller provisioning files are loaded on the MAP device 600, the MAP device 600 is prepared to independently configure the controllers.

Referring now to FIG. 9, a schematic diagram of a system 900 for controller provisioning with the MAP device 600 is shown, according to an exemplary embodiment. System 900 includes the MAP device 600 communicably coupled to a building network 902 via controller A 904 and communicably coupled to a user mobile device 906 (e.g., smartphone, tablet, laptop) via a Wi-Fi network 908.

The building network 902 provides for the exchange of communications between controller A 904 and multiple additional controllers, shown as controller B 910 through controller S2 912. Controller A 904 through controller i2 912 are included in a building management system, for example BMS 500 of FIG. 5. Accordingly, in some embodiments, controller A 904 through controller S2 912 correspond to various controllers shown in FIG. 5, for example VAV zone controllers 524, 532, 536, 550, COBP zone controllers 530, 548, PEAK controller 534, thermostat controller 516, and third party controller 520.

The MAP device 600 connects to the building network 902 via controller A 904, for example by a cable running from SA/FC bus port 610 to a corresponding port on controller A 904. In alternative embodiments, the MAP device 600 connects directly to the building network 902 or connects through some other bus, device, equipment, etc. on the building network 902.

The MAP device 600 draws power from the controller A 904 and the building network 904. Thus, the MAP device 600 does not require a separate, external power source. The MAP device 600 thereby provides controller provisioning in locations without accessible power sources, eliminating a common challenge in conventional approaches.

The MAP device 600 is also communicable with a user mobile device 906 via a Wi-Fi network 908 generated by the Wi-Fi Access Point 716 of the MAP device 600. Because the MAP device 600 provides the Wi-Fi network 908, no external network is needed in the location of controller provisioning to allow the MAP device 600 to communicate with the user mobile device 906.

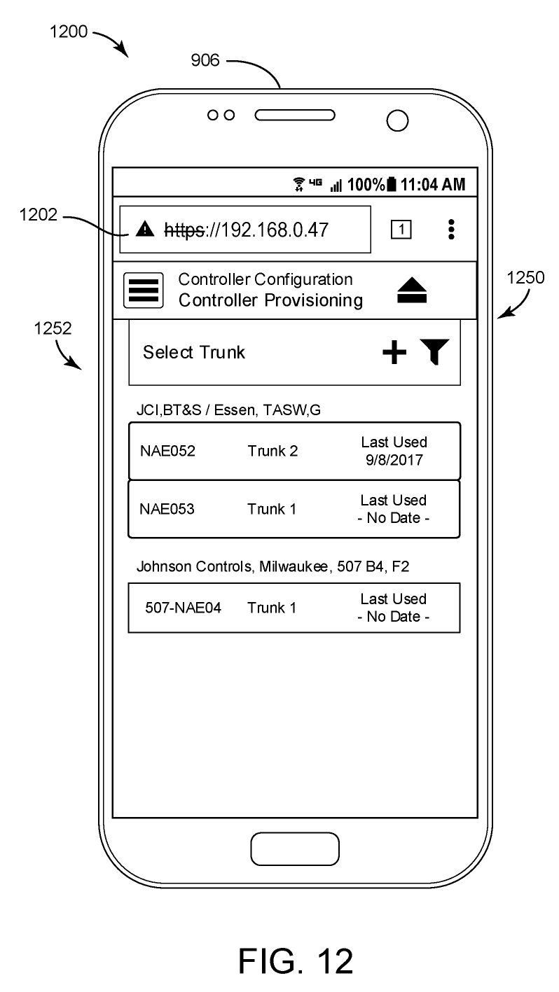

The MAP device 600 provides the user mobile device 906 with graphical user interfaces relating to controller provisioning. Examples of such graphical user interfaces are shown in FIGS. 12-14 and described in detail with reference thereto. In general, the graphical user interfaces provided to the user mobile device 906 present a user with information relating to the controllers available to be provisioned, options to select controllers and initiate loading of controller packages onto the selected controllers, status updates on the loading process, and options to pause or cancel loading for particular controllers or for all controllers. The user mobile device 906 and the graphical user interfaces presented thereon thus provide a user with the ability to control and monitor the provisioning of controllers by the MAP device 600.jjnj

For example, the user mobile device 906 may receive an input from a user commanding the controller packages to be loaded onto all available controllers (e.g., controller A 604 through controller S2 912). The user mobile device 906 transmits the request to the MAP 600. In response, the MAP 600 initiates the loading of controller packages onto the controllers 904-912. In many cases, loading of controller packages onto the controllers 904-912 takes a substantial amount of time (e.g., several hours, days). While loading is in progress by the MAP 600, the MAP 600 provides the user mobile device 906 with status updates on the progress (e.g., percentage overall complete, percentage loaded for each controller) and/or options to cancel loading.

While the MAP 600 is loading controller packages onto controllers, the user mobile device 906 can be freely disconnected and reconnected to the MAP 600 as desired by the user. The MAP 600 continues to load controller packages onto controllers, even when the user mobile device 906 is disconnected from the Wi-Fi network 908. The user mobile device 906 is therefore freed up for other functions, applications, etc. desired by the user, and can be removed from the proximity of the MAP 600 during controller provisioning. The ongoing controller provisioning requires no computing resources from the user mobile device 906. The user of the user mobile device 906 can therefore use the user mobile device 906 for other tasks relating to the installation of a building management system while the MAP 600 loads controller packages onto controllers, thereby increasing the efficiency of the installation process.

The MAP 600 loads the controller packages onto each controller by transmitting the controller packages to the corresponding controller via building network 902. The controller packages may include installation logic that facilitates the installation of the applications, firmware, tags, etc. in each controller package onto the corresponding controller.

When the MAP 600 has provisioned all selected controllers (i.e., loaded a corresponding controller package onto each controller selected by a user for provisioning), the MAP 600 provides an indication of completion to the user mobile device 906 via Wi-Fi network 908. A graphical user interface generated by the MAP 600 and presented to the user on the user mobile device 906 may include an option to select more controllers for provisioning or an indication that all available controllers have been provisioned.

When the user determines, based on information presented on the user mobile device 906, that the MAP 600 has completed controller provisioning, the MAP 600 can be disconnected from controller A 904 and the building network 902. The MAP 600 is therefore reusable for controller provisioning on multiple building networks, at multiple buildings/sites, etc. In some cases, the user may desire to leave the MAP 600 connected to the building network 902. In such cases, the MAP 600 provides a gateway for a user mobile device 906 to access functions, features, data, etc. available via the building network 902.

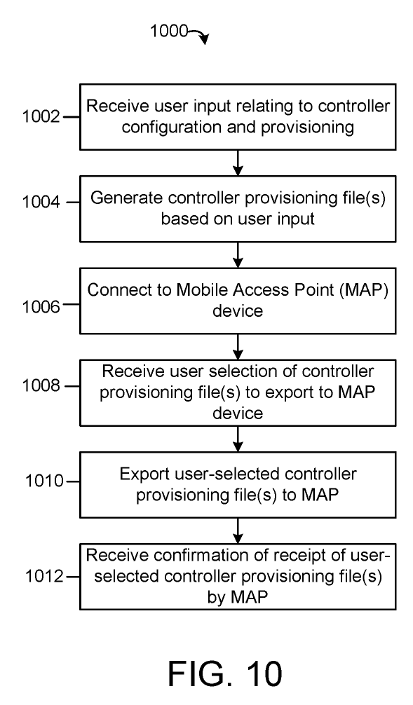

Referring now to FIGS. 10, a process 1000 for controller provisioning with the MAP device 600 is shown, according to an exemplary embodiment. Process 1000 may be carried out by the set-up computer 802 in communication with the MAP device 600.

Process 1000 starts at step 1002, where the set-up computer 802 receives user input relating to controller configuration and provisioning. For example, the set-up computer 802 may provide a graphical user interface to a user based on a SCT that provides options relating to controller configuration and provisioning.

Based on the user input received at step 1002, at step 1004 the set-up computer 802 generates one or more controller provisioning files. The controller provisioning file(s) includes the applications, parameters, tags, commissioning report file, firmware, bus provisioning, and/or other logic or data needed to provision controllers in a building management system. The controller provisioning file is in a MAP-to-Controller (.m2c) file format.

At step 1006, the set-up computer 802 connects to the MAP device 106. In some embodiments, the set-up computer 802 connects to the Wi-Fi access point 716 via the Wi-Fi network generated by the Wi-Fi access point 716. In other embodiments, the set-up computer 802 connects to the MAP device 106 via an Ethernet or USB cable. A communication session is established between the set-up computer 802 and the MAP device 106.

At step 1008, the set-up computer 802 receives a user selection of controller provisioning file(s) to export to the MAP device 600. For example, the set-up computer 802 may provide a graphical user interface that includes a selectable list of available controller provisioning files.

At step 1010, in response to a user selection of a controller provisioning file to export to the MAP device 600, the set-up computer 802 exports the selected controller provisioning file to the MAP device 600. The set-up computer 802 transmits the selected controller provisioning file to the MAP device 600, where the controller provisioning file is saved in the provisioning files database 704.

At step 1012, the set-up computer 802 receives confirmation from the MAP device 600 that the selected controller provisioning file was received by the MAP device 600. In some embodiments, the set-up computer 802 may access the provisioning files database 704 to view the files present in the provisioning files database 704 on the MAP device 600. In some embodiments, the user interface circuit 710 of the MAP device 600 accesses the provisioning files database 704 to generate a list of files present in the provisioning files database 704 and provides the list to the set-up computer 802 via the communications driver 702.

The role of the set-up computer 802 in controller provisioning as described herein ends at step 1012.

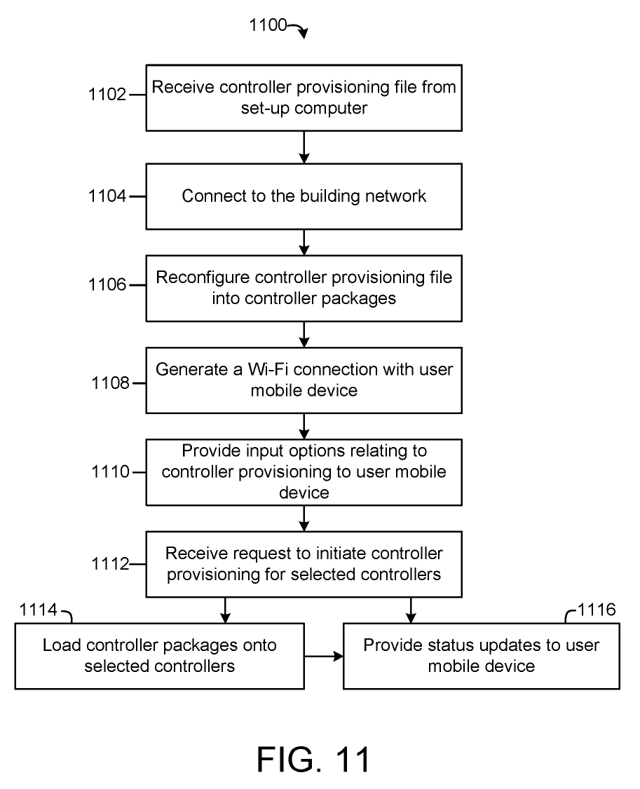

Referring now to FIG. 11, a flowchart of a process 1100 for controller provisioning by the MAP device 600 is shown, according to an exemplary embodiment. Process 1100 can be carried out by the MAP device 600 in communication with a user mobile device 906 and a building network 904 that serves one or more controllers (e.g., controller A 904 through controller S2 912). The process 1100 continues from the end of process 1000.

At step 1102, the MAP device 600 receives the controller provisioning file from the set-up computer 802. The MAP device 600 stores the controller provisioning file in the provisioning file database 704.

At step 1104, the MAP device 600 is connected to building network 902, for example via controller A 904. The MAP device 600 may automatically detect a network protocol used by the building network 902 and determine network address and other structural features of the building network 902 with the server circuit 706.

At step 1106, the MAP device 600 reconfigures the controller provisioning file into controller packages. Each controller package is a set of applications, parameters, tags, commissioning report files, firmware, bus provisioning, and/or other data or logic to be loaded onto a particular controller. The MAP device 600 may use information about the building network 902 determined by the server circuit 706 to properly configure the controller packages for transmission via the building network 904.

At step 1108, the MAP device 600 generates a Wi-Fi connection with a user mobile device 906. The MAP device 600 provides a Wi-Fi access point 716 that the user mobile device 906 connects to. A communication session is thereby established between the MAP device 600 and the user mobile device 906.

At step 1110, the MAP device 600 provides input options relating to controller provisioning to the user mobile device. The MAP device 600 generates a graphical user interface and transmits the graphical user interface to the user mobile device 906. The graphical user interface is presented to a user on the user mobile device 906 and includes user-selectable options. The user-selectable options include selectable controllers and an option to request that the selected controller(s) be provisioned. Examples of such graphical user interfaces are shown in FIGS. 12-14.

At step 1112, the MAP device 600 receives a user request to initiate controller provisioning for selected controllers. The MAP device 600 receives an indication from the user mobile device 906 that a user selected an option to initiate controller provisioning for a set of selected controllers. The MAP device 600 thereby learns which controllers the user desired that the MAP device 600 load with a corresponding controller package.

In response to request to initiate controller provisioning for selected controllers, at step 1114 the MAP device 600 loads controller packages on to the selected controllers. The controller packages are transmitted via the building network 902 to the corresponding controllers. The controllers receive the controller packages and allow the MAP device 600 to install the controller packages on the controllers. Step 114 may be carried out with or without continued communication with the user mobile device 906.

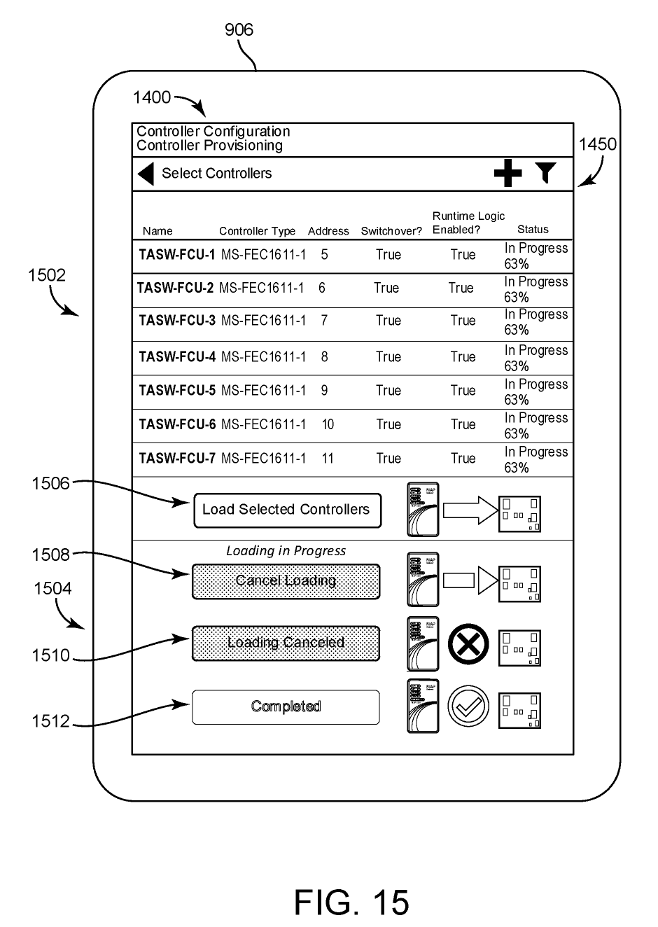

During the execution of step 1116, the MAP device 600 provides status updates to the user mobile device 906. The MAP device 600 generates a graphical user interface that indicates the progress made towards provisioning the controllers. An example of such a graphical user interface is shown in FIG. 15. The graphical user interface may include options to pause or cancel the provisioning of one or more controllers.

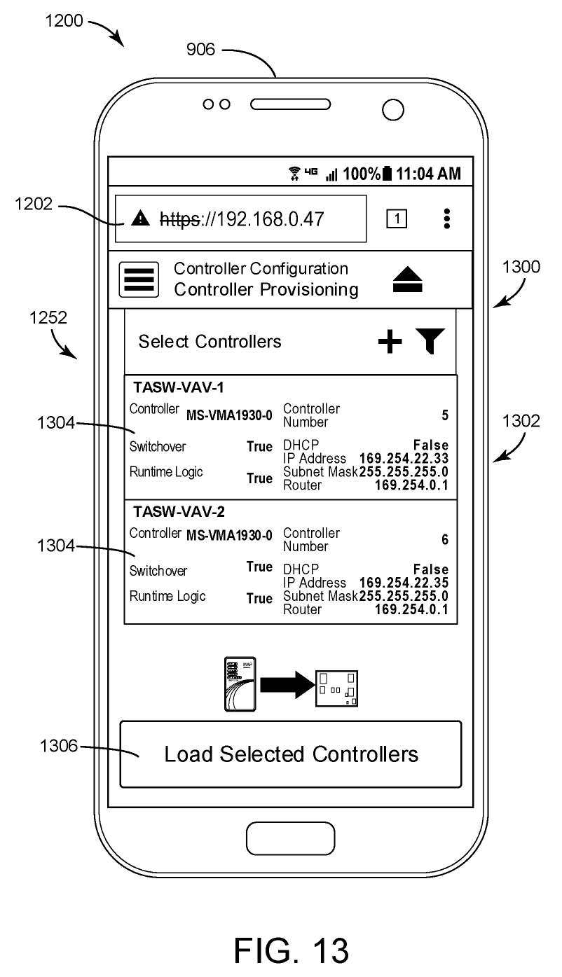

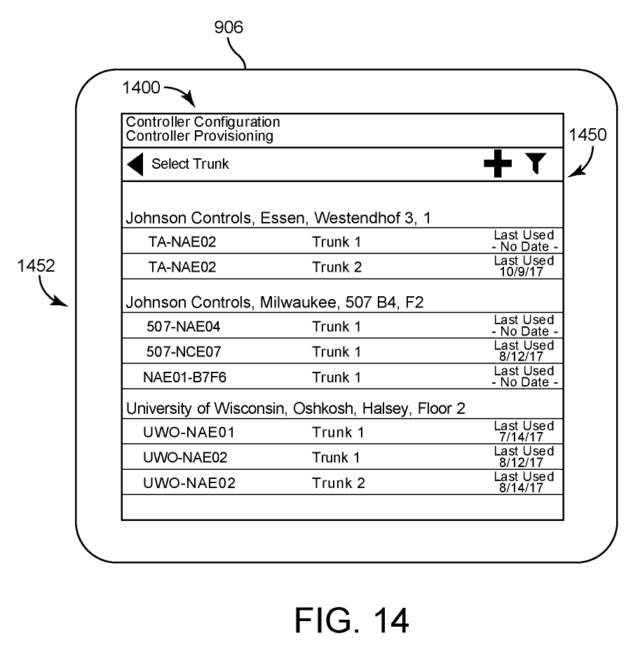

Referring now to FIGS. 12-15, a variety of graphical user interfaces generated by the MAP device 600 for display on the user mobile device 906 are shown, according to exemplary embodiments. FIGS. 12-13 show example graphical user interfaces configured for presentation on user mobile device 906 that is a smartphone, while FIGS. 14-15 show example graphical user interfaces configured for presentation on user mobile device 906 that is a tablet or a laptop.

Referring now to FIG. 12, a graphical user interface 1200 is shown on a user mobile device 906, according to an exemplary embodiment. The user mobile device 906 is connected to the Wi-Fi access point 716 of the MAP device 600, such that the graphical user interface 1200 can be accessed by navigating a browser application of the user mobile device 906 to an IP address associated with the MAP device 600, as shown in address bar 1202. FIG. 12 shows a trunk-level view 1250 of the graphical user interface 1200. The trunk-level view 1250 includes a list 1252 of user-selectable trunks. Each trunk on the list 1252 corresponds to a group of controllers that can be provisioned simultaneously (i.e., by the MAP device 600 connected to a single building network 902 without the need to reconnect elsewhere), or to some other division or categorization of controllers. In some embodiments, the list 1252 only includes entries that correspond to controllers currently in communication with the MAP device 600. The list 1252 includes identifying information for each entry on the list including a name and a last-used date. An entry on the list 1252 can be selected by a user to enter a controller view 1300 of the graphical user interface 1200, shown in FIG. 13.

Referring now to FIG. 13, a controller view 1300 in the graphical user interface 1200 is shown, according to an exemplary embodiment. The controller view 1300 includes a list 1302 of controllers available for provisioning. In the embodiment shown, each controller on the list 1302 is in communication with the MAP device 600 via the building network 902. Each selectable entry 1304 on the list 1302 includes indications of the corresponding controller's name, type, addresses, number, and other information. The selectable entries 1304 can be selected by a user by tapping, touching, etc. on the selectable entries 1304. The controller view 1300 also includes a load selected controllers button 1306 that can be selected by a user to request that the MAP device 600 load the selected controllers.

Referring now to FIG. 14, a graphical user interface 1400 is shown on a user mobile device 906, according to an exemplary embodiment. As noted above, FIGS. 14-15 show examples where the user mobile device 906 is a tablet or laptop. The graphical user interface 1400 of FIG. 14 includes a trunk-level view 1450 of the graphical user interface 1400. The trunk-level view 1450 includes a list 1452 of user-selectable trunks. Each trunk on the list 1452 corresponds to a group of controllers that can be provisioned simultaneously (i.e., by the MAP device 600 connected to a single building network 902 without the need to reconnect elsewhere), or to some other division or categorization of controllers. In some embodiments, the list 1452 only includes entries that correspond to controllers currently in communication with the MAP device 600. The list 1452 includes identifying information for each entry on the list including a name and a last-used date. The list 1452 may include more than one entry for a trunk, indicating that multiple controller provisioning files are available on the MAP device 600 for that trunk. As compared to the trunk-level view 1250 of FIG. 12, more entries can be included in a single view on the larger screen of the example of FIG. 14. An entry on the list 1452 can be selected by a user to enter a controller-level view 1500 of the graphical user interface 1400, shown in FIG. 15.

Referring now to FIG. 15, a controller-level view 1500 of the graphical user interface 1400 on user mobile device 906 is shown, according to an exemplary embodiment. The controller-level view 1500 shows a list of controllers 1502 and a variety of indicators 1504 that may be included with the list of controllers 1502. The list of controllers 1502 includes identifying information about listed controllers, including a controller provisioning status (e.g., in the example of FIG. 15 all controllers are 63% through a controller package loading process). Although multiple indicators 1504 are shown if FIG. 15, it should be understood that the variety of indicators 1504 are presented side-by-side for the sake of comparison and that in preferred embodiments one of the variety of indicators 1504 is included with controller-level view 1500 as appropriate. More particularly, the indicators 1504 include a load selected controllers option 1506 that can be selected to request that the MAP device 600 load controller packages on the selected controllers, a cancel loading option 1508 that can be selected to stop ongoing loading by the MAP device 600, a loading canceled indicator 1510 that indicates that loading has been cancelled, and a loading completed indicator 1512 that indicates when loading of the controller package onto the controller by the MAP device 600 is complete. The controller-level view 1500 thereby provides various information and options to a user of the user mobile device 906.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations. The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, calculation steps, processing steps, comparison steps, and decision steps.

What is claimed is:

1. A portable device comprising:
a communication driver configured to facilitate communication between the portable device and a plurality of controllers on a building network and between the portable device and one or more personal computing devices, the plurality of controllers configured to control building equipment for a building;
a controller load circuit configured to:
receive a controller provisioning file;
identify controller packages from the controller provisioning file, each controller package comprising provisioning information for a corresponding controller of the plurality of controllers; and
install each controller package on the corresponding controller.

2. The portable device of claim 1, wherein the one or more personal computing devices comprise a set-up computer and a mobile device, the set-up computer configured to create the controller provisioning file and provide the controller provisioning file to the portable device, and the mobile device configured to receive status updates on the installation of controller packages from the portable device.

3. The portable device of claim 2, wherein:
the set-up computer is located at a remote location from the building;
the portable device is portable from the remote location to the building; and
the portable device is configured to be disconnected from the building network after installation is complete.

4. The portable device of claim 3, wherein the communication driver facilitates communication between the portable device and the plurality of controllers using BACnet or MSTP and between the portable device and the mobile device using Wi-Fi.

5. The portable device of claim 1, wherein the portable device is configured to be coupled to a first controller of the plurality of controllers and to draw power from the first controller.

6. The portable device of claim 5, wherein the first controller is communicable via the building network and wherein the portable device accesses the building network via the first controller.

7. The portable device of claim 1, wherein the controller packages include applications, parameters, tags, commissioning report files, sensor-actuator bus provisioning, and/or firmware.

8. A method for provisioning controllers, the method comprising:
receiving, by a portable device, a controller provisioning file;
configuring, by the portable device, controller packages based on the controller provisioning file for a plurality of controllers, each controller communicable with the portable device via a building network;
providing, by the portable device, a graphical user interface to a user mobile device via a wireless network;
receiving, by the portable device from the user mobile device, a user request to initiate installation of selected controller packages; and
installing the selected controller packages on corresponding controllers of the plurality of controllers.

9. The method of claim 8, wherein the controller provisioning file is generated by a set-up computer and transmitted from the set-up computer to the portable device.

10. The method of claim 9, wherein:
the controllers control building equipment in a building to provide heating or cooling to the building; and
the set-up computer is located remotely from the building.

11. The method of claim 8, wherein the building network is based on BACnet or MSTP and the wireless network is a Wi-Fi network.

12. The method of claim 8, further comprising
accessing, by the portable device, the building network via a first controller; and
drawing, by the portable device, electrical power from the first controller.

13. The method of claim 8, wherein the controller packages include applications, parameters, tags, commissioning report files, sensor-actuator bus provisioning, and/or firmware.

14. The method of claim 8, further comprising selectively disconnecting the portable device from the mobile device during installation of the controller packages.

15. A method comprising:
generating, by a personal computer at a first location, a controller provisioning file;
importing the controller provisioning file from the personal computer to a portable device;
transporting the portable device to a second location;
connecting the portable device to a first controller of a plurality of controllers, the plurality of controllers communicable via a building network;
generating a communication session between the portable device and a user mobile device;
receiving, by the portable device from the user mobile device, a user request to install controller packages from the controller provisioning file on one or more selected controllers of the plurality of controllers; and
installing, by the portable device via the building network, the controller packages on the one or more selected controllers.

16. The method of claim 15, further comprising:
transmitting, from the portable device to the user mobile device, status updates on installation of the controller packages;
providing, on the user mobile device, a graphical user interface comprising the status updates.

17. The method of claim 15, further comprising selectively connecting and disconnecting the user mobile device from the portable device during installation of the controller packages on the one or more selected controllers.

18. The method of claim 15, further comprising powering the portable device by drawing electrical power from the first controller.

19. The method of claim 15, wherein the plurality of controllers control building equipment to heat or cool a building at the second location.

20. The method of claim 15, further comprising reconfiguring, by the portable device, the controller provisioning file to generate the controller packages, the controller packages configured to be transmitted via the building network.
